(19) United States
(12) Patent Application Publication
(10) Pub. No.: US 2024/0281878 A1
(43) Pub. Date: Aug. 22, 2024

(54) Algorithmic Computer Trading System

(71) Applicant: Maanav Modi, Suwanee, GA (US)

(72) Inventor: Maanav Modi, Suwanee, GA (US)

(21) Appl. No.: 18/171,337

(22) Filed: Feb. 18, 2023

(51) Int. Cl. G06Q 40/04

(52) U.S. Cl. CPC G06Q 40/04

(57) ABSTRACT

Embodiments of the present disclosure may include an algorithmic computer trading system for facilitating electronic processing of data for execution of trades, the system including a computer implemented module adapted to receive a connection to a financial exchange allowing trading of assets in the exchange. Embodiments may also include a computer implemented module adapted to receive trading rules defined by a trader, the rules being based at least in part on an asset of trade, a trade time-frame, buy and sell rules, quantity of traded asset and machine-defined rules defined by machine learning extracted patterns. Embodiments may also include a trading algorithm executing a trading process based on received trading rules as a thread in a compute environment, where the trading thread process compute resource utilization may be measured as a portion of available compute resources.

### FIELD OF INVENTION

The present invention relates to an algorithmic computer trading system for facilitating electronic processing of data for execution of trades. The system includes a computer implemented module for receiving a connection to a financial exchange, allowing trading of assets in the exchange, as well as a module for receiving trading rules defined by a trader. The trading algorithm executes a trading process based on the received trading rules and measures the trading thread process compute resource utilization as a portion of available compute resources.

### BACKGROUND OF THE INVENTION

Automated computer trading algorithms have come a long way over the years, becoming increasingly sophisticated and efficient in facilitating electronic processing of data for the execution of trades. The use of algorithmic trading has become more widespread in recent years, as traders look for ways to maximize profit and improve efficiency.

One of the key advantages of algorithmic trading is that it allows traders to execute trades at a much faster rate than manual trading. This is because algorithmic trading systems are able to process large amounts of data and execute trades in milliseconds, while human traders would take much longer to process the same information and make a trade. This speed advantage can be particularly beneficial in fast-moving markets, where every second counts.

Another advantage of algorithmic trading is that it allows traders to make more informed decisions. Algorithmic trading systems can be programmed to take into account a wide range of data, including historical data, market trends, and news events. This enables traders to make more informed decisions about when to buy and sell assets, and to identify patterns that may not be immediately obvious to human traders.

Algorithmic trading systems can also be programmed to execute trades based on a wide range of rules and conditions. For example, a trader may define trading rules based on an asset of trade, a trade time-frame, buy and sell rules, quantity of traded asset and machine-defined rules defined by machine learning extracted patterns. This flexibility allows traders to tailor their trading strategies to suit their individual needs and goals.

In addition, algorithmic trading systems can be programmed to control the amount of resources they consume, such as memory and processing power, by measuring the trading thread process compute resource utilization as a portion of available compute resources. This ensures that the algorithm does not consume too many resources and cause other systems to lag.

Overall, algorithmic trading has many advantages over manual trading, including speed, precision, and flexibility. As the technology continues to advance, it is likely that we will see even more sophisticated and efficient algorithmic trading systems in the future.

It is thus an objective of the present invention to provide an algorithmic computer trading system that facilitates electronic processing of data for execution of trades, by including a computer implemented module that receives a connection to a financial exchange, allowing trading of assets in the exchange, as well as a module that receives trading rules defined by a trader. It is also an objective of this invention to provide a trading algorithm executes a trading process based on the received trading rules and measures the trading thread process compute resource utilization as a portion of available compute resources. The described system aims to increase efficiency and profitability of trading by providing a faster, more informed and adaptable approach to trades.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

Embodiments of the present disclosure may include an algorithmic computer trading system for facilitating electronic processing of data for execution of trades, the system including a computer implemented module adapted to receive a connection to a financial exchange allowing trading of assets in the exchange. Embodiments may also include a computer implemented module adapted to receive trading rules defined by a trader, the rules being based at least in part on an asset of trade, a trade time-frame, buy and sell rules, quantity of traded asset and machine-defined rules defined by machine learning extracted patterns.

Embodiments may also include a trading algorithm executing a trading process based on received trading rules as a thread in a compute environment, where the trading thread process compute resource utilization may be measured as a portion of available compute resources. In some embodiments, each trading thread process may be identifiable to its unique set of rules and financial exchange connection, and. Embodiments may also include a trading thread monitor adapted to keep track of received trading rules to determine alteration of trading rules received thus start a trading process thread based on new rules, or restart a trading process new thread if significant changes to the rules may be determined.

In some embodiments, the trading system may include a consumer module coupled thereto via a data communication network and being adapted to provide a connection to at least one financial exchange defining tradable assets. Embodiments may also include select a financial exchange connection for trading an asset at the creation of a trading process thread. Embodiments may also include select/create rules for trading including at least in part a trade time-frame, buy and sell rules, quantity of traded asset, and. Embodiments may also include submit for execution the financial exchange connection and trading rules by the algorithmic computer trading system.

In some embodiments, the module adapted to receive trading rules may include a real-time database. In some embodiments, the trading thread monitor executes the financial exchange connection and trading rules as a processor thread, the thread including a trading algorithm identifiable to the received trading rules.

In some embodiments, the financial exchange connection may be an API key. In some embodiments, the trading system may include in the trading thread monitor a suitably trained machine learning algorithm adapted to determine the trading steps taken by a trading algorithm. Embodiments may also include determine similar steps taken by previous trading algorithms by analysis of previously stored trading rules. Embodiments may also include determining the success of similar steps based on the growth of traded asset. Embodiments may also include modifying the trading rules to maximize the growth of traded asset. In some embodiments, the trading system, further causing the start trading process thread based on modified trading rules. In some embodiments, the growth of asset may be determined by increase in asset value after trading strategy execution, with the value being stores in a real-time database.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 is a graphical user interface operable by a user according to one embodiment.

FIG. 2 is a block process flow diagram illustrating an algorithmic execution according to some embodiments of the present disclosure.

FIG. 3 is a database for storing trading rules for algorithmic trade execution, according to some embodiments of the present disclosure.

FIG. 4 is a schematic diagram, according to some embodiments of the present disclosure.

FIG. 5 is a resource management illustration according to some embodiments of the present disclosure.

FIG. 6 is a block diagram illustrating an algorithmic computer trading system, according to some embodiments of the present disclosure.

FIG. 7 is a flowchart illustrating a method, according to some embodiments of the present disclosure.

FIG. 8 is a flowchart further illustrating the method from FIG. 7, according to some embodiments of the present disclosure.

FIG. 9 is a flowchart further illustrating the method from FIG. 7, according to some embodiments of the present disclosure.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

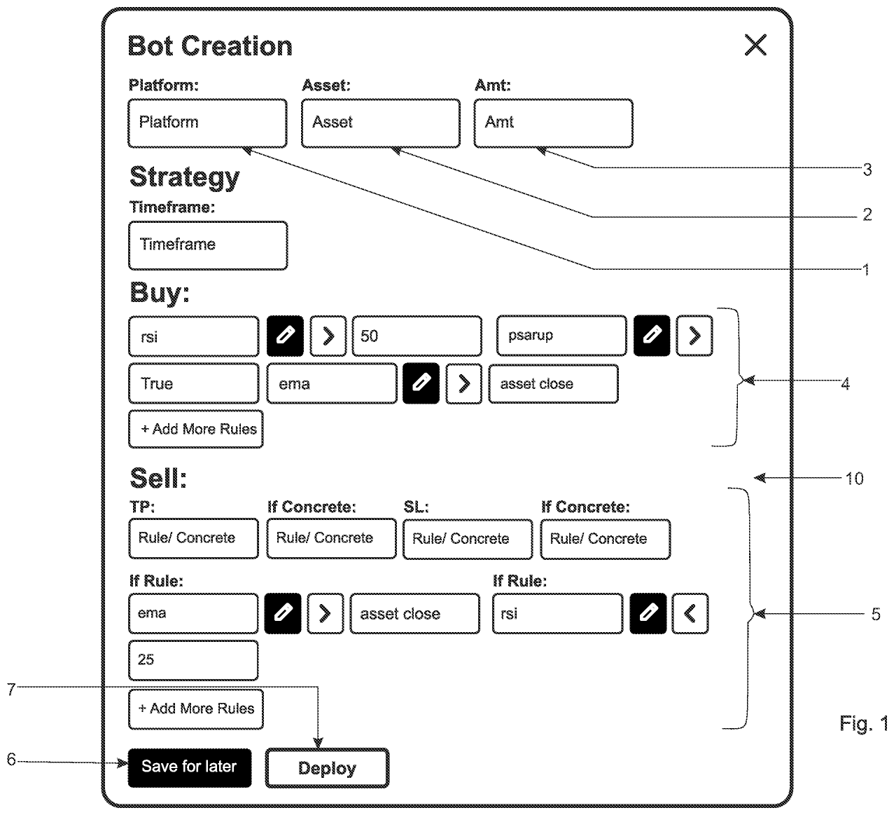

The embodiment according to the FIG. 1 is a graphical user interface (GUI) operable by a user according to one embodiment. The graphical user interface (GUI) is executed in a computing device, preferably a portable computing device such as a smartphone, smart watch, laptop, tablet, a personal computer or any such. In one embodiment, the GUI is part of a public-facing portal that allows users to create and manage their own automated trading bots or trading thread or trading algorithms, and may be served on either through a pay-peruse model or a subscription plan. Typically, for each input, it is generated a trading thread with an algorithm which is based on the input rules. In this context, a thread is an execution unit that has its own program counter, a stack and a set of registers that reside in a process and for purposes of this disclosure, the trading thread is an autonomous algorithm or bot that operates based on trader-defined or machine-defined rules. Threads can't exist outside any process. Also, each thread belongs to exactly one process.

As seen in the exemplary interface 10, it is provided an input means for a user to select a financial exchange or trading platform (whose access may be previously granted such as through a secure API credential interchange or by providing secure access keys), an asset to trade from the connected platform (e.g. cryptocurrency, gold, silver among others) as well as the amount to be traded as seen in 1, 2 and 3 on the interface. Next, is the specifying of buying rules 4 and selling rules 5 for the execution of a trading strategy by a trading thread. A user may include multiple inputs and strategies as shown on the interface, and the trading threads in such instances would be executed as a multi-threaded process in a corresponding computing instance, which is a process with multiple threads, each thread corresponding to a trading strategy for a traded asset at a financial exchange. Inputs from the user may be deployed as shown in 7, which entails transmitting the trading rules to a server for execution, typically at a remote location.

In some aspects, a suitably trained machine learning algorithm may analyse the trading rules in context of current market data to determine the suitability of the rules to a trading rules to a strategy, for instance a risky or conservative strategy. Based on this analysis, the machine learning algorithm may recommend amendment of trading rules before their submission for execution as a process thread. Additionally, it may be provided a means 6 for storing rules temporarily for further review.

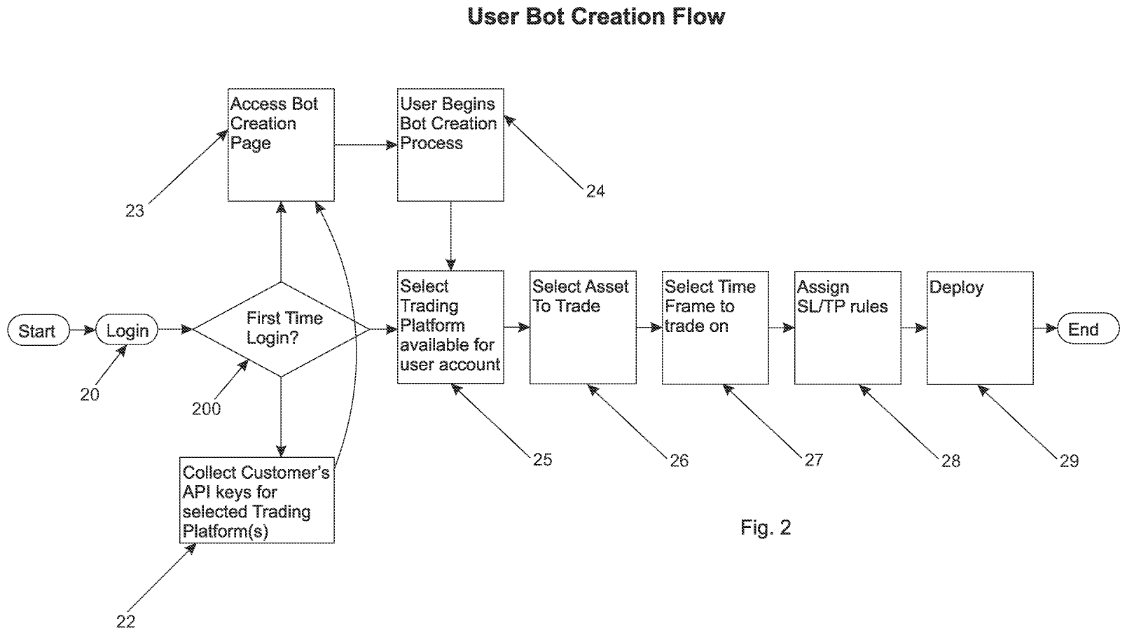

Now referring to FIG. 2 is a block process flow diagram illustrating an algorithmic execution according to some embodiments of the present disclosure. This process allows the log in 20 users to financial exchange platforms and grant permission to access market data, view cash and assets in their account, and execute buying and selling actions based on conditions set by users as well as other machine conditions or rules. In the non-limiting illustration, it may be provided a determination if user has previously connected to a financial exchange or trading platform as in 200, thus necessitating connecting to such a trading platform by, for example receiving API keys or some other authentication data as in 22, which may now enable access to a graphical user interface to start the creation of the trading rules as in 23. Generally, via a provided graphical user interface operable on a portable computing device, a user may provide a connection to one or more financial exchange defining tradable assets through the provision of secure access means such as credentials, and thereafter, they can begin the creation of their unique rules as in 24, which may be as demonstrated in FIG. 1 to execute as a trading thread in a computing hardware environment. The process flow diagram further shows a selection of a financial exchange connection 25 for trading a selected asset as in 26 at the creation of a trading process thread. This creation of a trading thread may typically be carried out by a trading thread monitor.

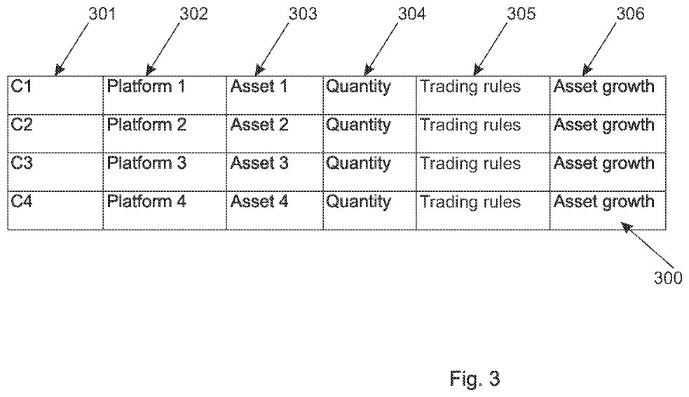

Further shown in the process flow is the selection or creation of rules using a graphical user interface for trading including a trade time-frame 27, buy and sell rules 28, for the selected quantity of traded asset, and the submitting 29 of the selected/created rules for execution by the algorithmic computer trading system. The rules and selections may be stored in a database as in FIG. 3.

In FIG. 3 is an exemplary non-limiting database for storing trading rules for algorithmic trade execution, according to some embodiments of the present disclosure. In this example, the database is shown to store trading rules and other data including an identifier, trade platform, asset, quantity, and rules, as well as the user who created them and the last time they were updated or started. This stored data is then available to manage and monitor the active Bots (trade threads), as well as to provide relevant information to the user.

According to some non-limiting embodiments, the stored data fields necessary for the execution may include among others: a user identifier being a string that identifies the user who is creating the rules for bots, a bot identifier 301 being a string that identifies the bot, a platform identifier 302 being a string that specifies which platform the Bot should use to execute trades. This typically includes a platforms for which connection is provided, an asset 303 being a string that specifies which asset the Bot should trade, an amount being a value that specifies the amount of the asset that the Bot should trade. Additionally, the data field may include a time-frame being a part of the trading rules string that specifies the time-frame of the market data that the Bot should use, which may be in minutes, hours, days, weeks or even months. The rules 305 may generally specify the rules that the Bot should use to determine when to buy or sell. Such rules may be stored including a rule name, a rule type that specifies whether the rule is a ‘buy’ or ‘sell’ rule, an indicator that specifies the market or financial exchange indicator that the rule is based on as well as indicator parameters that specify the parameters for the indicator. Generally, operators specify the comparison operator to use in the rule, for example “>”, “<”, “>=”, “<=”, “=” or “!=”.

In a non-limiting example, there may be other stored data fields such as the time to run specifying how long the Bot should run for as well as the times to run such as the day of the week and time, and may also store asset growth 306. The stored data field may then cause a trading thread monitor to start a trading process thread based on modified trading rules.

In a non-limiting example, as the trader inputs their trading rules into a graphical user interface (GUI) provided by the trading system. These rules may include information such as the assets to be traded, the time-frame of the trade, the buy and sell rules, and the quantity of the asset to be traded, which may be the object of analysis of a trained machine learning algorithm designed to improve profitability of the strategy.

In such examples, the algorithm, which has been previously trained on historical market data and trading rules, receives the trader's rules as input. The algorithm uses its trained model to analyze the trader's rules in the context of current market conditions. The model uses the data to make predictions about the outcome of trades based on the trader's rules, and uses these predictions to assess the viability of the strategy.

Based on the predictions, the algorithm can make recommendations to the trader for adjusting their trading rules. For example, if the algorithm predicts that the strategy is unlikely to be profitable, it may recommend changes to the trader's entry or exit points, or suggest that they consider different assets or time-frames. The trader may then review the algorithm's recommendations and make a decision on whether to implement them. The trader can also input the updated rules and check the viability of the new strategy before executing it.

As the algorithm receives new market data, it can continuously monitor the performance of the strategy, and make new recommendations as needed. This allows the trader to continually improve their strategy over time.

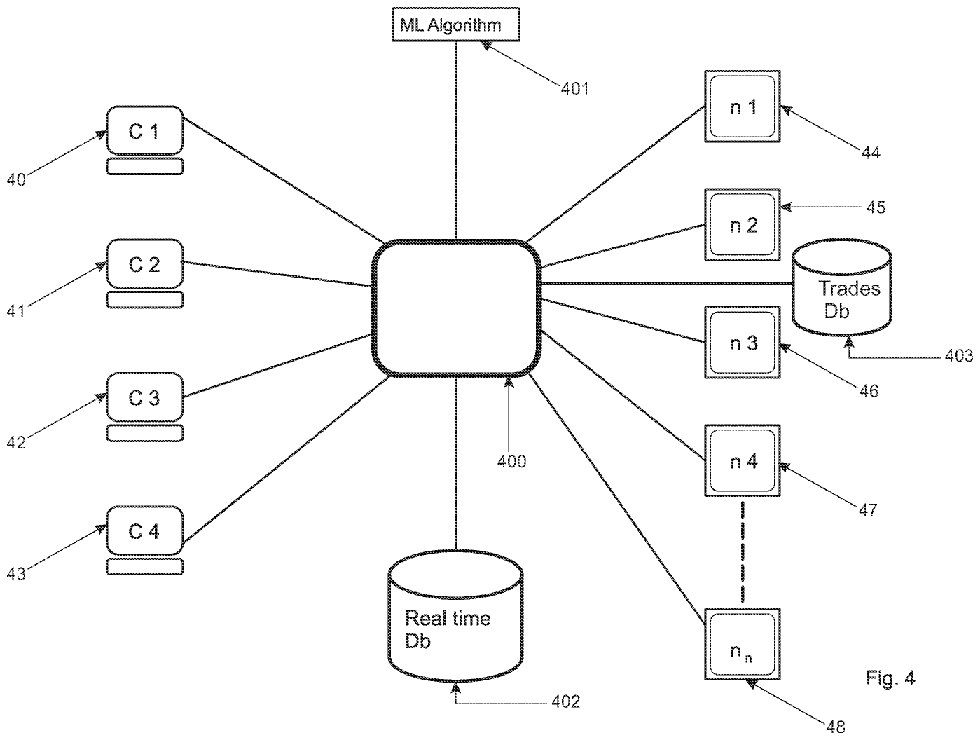

The example of FIG. 4 is a schematic diagram, according to some embodiments of the present disclosure. In the figure, it is shown devices 40, 41, 42 and 43 that may be adapted to receive trading rules inputs from users. In this example, after the rules and other conditions generated by respective computing devices such as 40, 41, 42 and 43, and are stored in the database 402 (which may comprise a real-time database) as in FIG. 3, the trading thread monitor 400 may execute the trading threads as separate threads 44, 45, 46, 47 and 48 all based on the stored strategic rules, and each corresponding to trade rules provided by the respective devices. The separate threads trading processes may be tracked and logged in a trades database 403, which may be configured to store execution history and corresponding market data, profit and loss, and any trade related activity performed by and related to a corresponding bot or thread

In one aspect the current invention entails proper separation of the threaded processes, such as 44, 45, 46, 47 and 48, where each can achieve its trading strategy independent of other threads. The synchronization is such that the bots do not to become deadlocked, meaning that they become stuck waiting for each other and are unable to make progress. Additionally, it helps mitigate race conditions. If threads are not properly synchronized, it is also possible for them to experience race conditions, where the behavior of the program depends on the order in which threads execute.

In the figure, a suitably trained machine learning algorithm 401 may be incorporated into the trading thread monitor typically to incorporate machine rules with trader rules. Generally, and without limitation such a machine learning algorithm may be capable of optimizing decision-making processes in trading to improve the rates of success through analysis of trading strategy against current market conditions. The algorithm may function by determining the trading steps taken by a trading algorithm and then analyzing and comparing them to similar steps taken by previous trading algorithms using previously stored trading rules. The algorithm may then use this information to determine the success of similar steps based on the growth of the traded asset. The ultimate goal is to modify the trading rules in order to maximize the growth of the traded asset and improve profitability of the trading strategy.

According to some aspect, the training process of this algorithm may begin by collecting historical data of the traded asset's performance, including the trading rules and actions that were used and the resulting asset growth. This means that the training data would include information such as the asset being traded, the time-frame of the trade, the buy and sell rules, and the quantity of the asset traded. The algorithm would also be provided with the profit or loss and win rate associated with each trade. The algorithm would then analyze this data to identify patterns and relationships between the trading rules and market conditions. The goal of this training phase is to build a model that can accurately predict the outcome of trades based on the given trading rules and market data.

Once the model is trained, it can be applied to new market data and trading rules supplied by a user. The algorithm would analyze the current market conditions and the user's trading rules, and use the trained model to predict the likely outcome of a trade. Based on this prediction, the algorithm can make a recommendation to the user, such as adjusting their trading rules to increase the chances of a profitable trade.

The algorithm can also continuously monitor the markets, and keep updating its model with new data and feedback. As it updates the model, it will adjust its prediction and recommendations accordingly.

Generally, and without limitation, in this context the training of a machine learning algorithm for a trading system typically involves the following steps:

Data collection: Historical market data, such as prices, trading volumes, and other relevant information, is collected for the assets and time-frames of interest. This data is used to train the algorithm and develop a model that can make predictions about future market conditions.

Data preprocessing: The collected data is cleaned, transformed, and normalized to ensure that it is in a format that can be used by the algorithm.

Feature engineering: The data is then transformed into a set of features that the algorithm can use to make predictions. This step is crucial as it is where the domain knowledge comes in to play and has a big impact on the performance of the model.

Algorithm selection: A machine learning algorithm is selected based on the type of problem being solved and the characteristics of the data.

Model training: The algorithm is trained on the preprocessed data, using a technique such as supervised learning. The goal is to optimize the parameters of the model such that it can accurately predict the outcome of trades based on the given trading rules and market data.

Model evaluation: The trained model is evaluated using a set of metrics, such as accuracy, precision, recall, and F1-score, to assess its performance. If the performance is not satisfactory, the model is refined or retrained with different parameters.

In some aspects, and without limitation, common algorithms that may be utilized may include:

Neural Networks: for their efficiency in prediction and pattern recognition tasks, particularly in the context of time-series data.

Random Forest: It is an ensemble method that uses a combination of decision trees to make predictions, which can be robust in the presence of noisy data or non-linear relationships such as market data.

Gradient Boosting: It is an ensemble method that iteratively improves a weak model by adding new models, which are trained to correct the mistakes of the previous models, and as such can improve the efficiency of prediction models.

Support Vector Machines (SVMs): for their efficiency in classification problems, and can be used to classify trades as profitable or unprofitable based on trading rules.

Time-series models: models such as ARIMA, Holt Winters, and GARCH are specially designed to handle time-series data and can be used to predict future market conditions.

In some aspects, such an algorithm may use a process such as Q-learning, which is an off-policy algorithm that uses the Bellman equation to update the Q-values of the trading rules. The Q-value represents the expected future reward of a specific action in a specific state. The algorithm starts with initial estimates of the Q-values and updates them as it receives feedback from the environment in the form of the asset growth. The algorithm then uses these updated Q-values to select the trading rules that are expected to lead to the highest asset growth. Another algorithm that could be used for this task is SARSA, which is also a type of reinforcement learning algorithm that focuses on updating the Q-values based on the current policy.

It is important to note that in order to make a good decision, the model must be fed with good amount of data, if the data is not enough the model will not be able to generalize well and make good decision. The model should also be tested and evaluated with unseen data in order to ensure its performance.

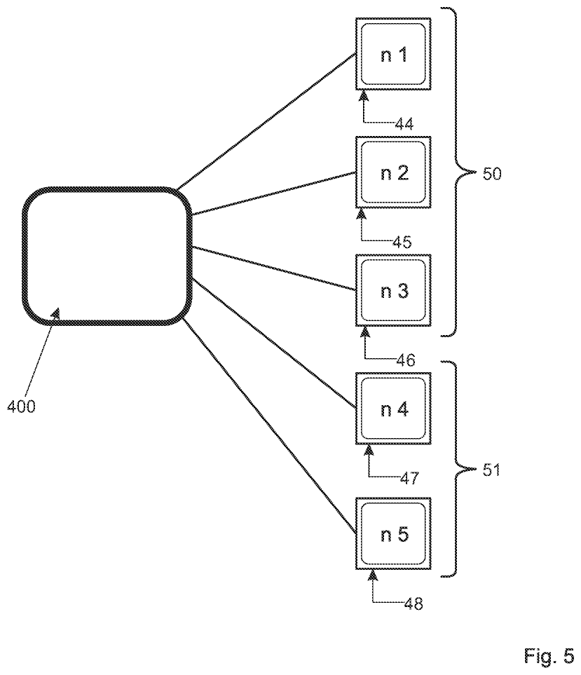

Now, the FIG. 5 is a resource management illustration according to some embodiments of the present disclosure. In this non-limiting embodiment a a trading thread monitor 400 may allocate compute resources to trading threads 44, 45, 46, 47 and 48B based on the resource utilization of processes running them. In the figure, a trading thread monitor may allocate available compute resources to a series of threads based on their resource utilization. In the example, a first group of threads(bots) 50 are executed in a first compute resource such as a virtual server or container, while a second group of threads 51 are executed in a second compute resource. By running multiple Bots on separate threads, resources such as CPU and memory can be shared more efficiently, allowing for more Bots to be run on a single machine.

The architecture has several advantages such as improved fault tolerance since if a Bot running on a separate thread encounters an error or crashes, it will not affect the overall system or other Bots running on separate threads. This improves the fault tolerance of the system as a whole.

For example, the threads in the first group may be reorganized based on changing resource requirements and transferred to the second group and vice versa.

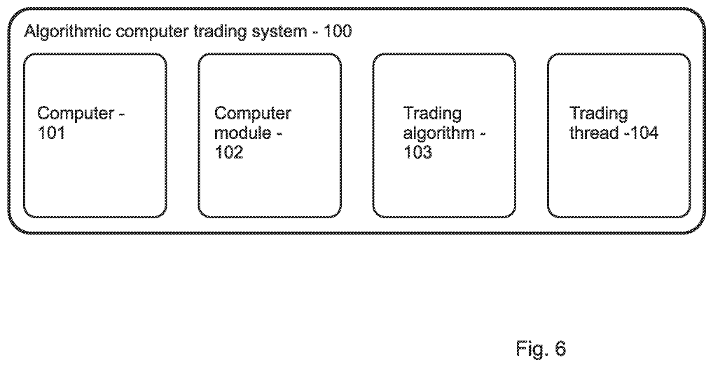

The embodiment according to FIG. 6 is a block diagram that describes an algorithmic computer trading system 100, according to some embodiments of the present disclosure. In some embodiments, the algorithmic computer trading system 100 may include a computer implemented module 101 that may be configured to receive a connection to a financial exchange thus allowing trading of assets in the exchange. The algorithmic computer trading system 100 may also include a computer implemented module 102 adapted to receive trading rules defined by a trader, the rules being based at least in part on an asset of trade, a trade time-frame, buy and sell rules, quantity of traded asset and machine-defined rules defined by machine learning extracted patterns. This may be a database or data store of some kind.

In some embodiments, the algorithmic computer trading system 100 may also include a trading algorithm 103 executing a trading process based on received trading rules as a thread in a compute environment, where the trading thread process compute resource utilization may be measured as a portion of available compute resources.

Further, the algorithmic computer trading system 100 may also include a trading thread monitor 104 adapted to keep track of received trading rules to determine alteration of trading rules received thus start a trading process thread based on new rules, or restart a trading process new thread if significant changes to the rules may be determined. Each trading thread process may be identifiable to its unique set of rules and financial exchange connection.

In some embodiments, the algorithmic computer trading system 100 may include a consumer module coupled via a data communication network and thus enable it to capture trader input of a connection financial exchanges that have defined tradable assets. The consumer module may also allow the selection of financial exchange connection specific for trading assets at the creation of a trading process thread, to select/create rules for trading, which may include among other things trade time-frame, buy and sell rules, quantity of traded asset. Submit for execution the financial exchange connection and trading rules by the algorithmic computer trading system 100.

In some embodiments, the module may be adapted to receive trading rules. In some embodiments, the trading thread monitor 104 may execute the financial exchange connection and trading rules as a processor thread or bot autonomously trading assets. Each trading algorithm may identifiable to the received trading rules such as by having a process identifier identifiable to stored rules. In some embodiments, the financial exchange connection may be an API key. In some embodiments, in the trading thread monitor may be included a trained machine learning algorithm that can determine the trading steps taken by a trading algorithm. Further, based on a trained model, determine similar steps taken by previous trading algorithms by analysis of previously stored trading rules and thus determining the success of similar steps based on the growth of traded asset. It may be provided that the growth of asset may be determined by increase in asset value after trading strategy execution, whereby the value of asset is store in a real-time database with each strategy execution or on a continuous basis as may be necessary.

In some embodiment, there may be the modifying the trading rules to maximize the growth of traded asset causing the start trading process thread based on modified trading rules executed by a machine learning algorithm.

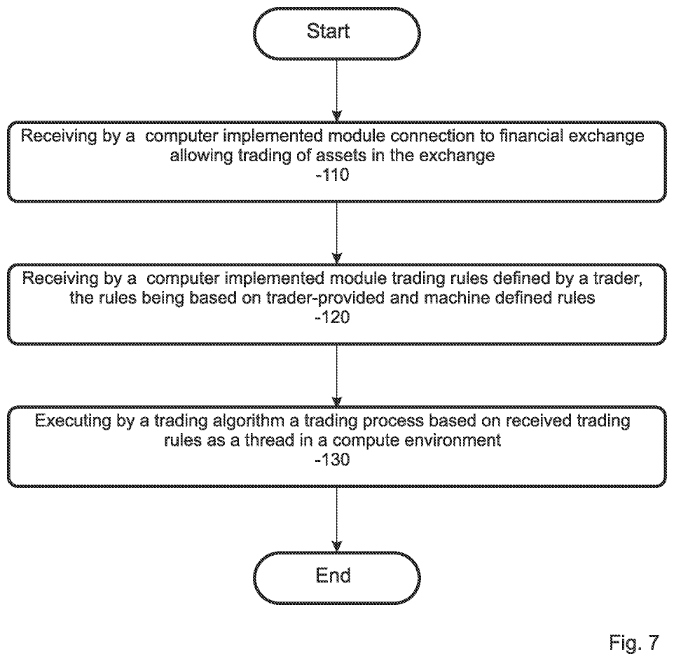

In the FIG. 7 is a flowchart that describes a method, according to some embodiments of the present disclosure. In some embodiments, a computer program product may execute a method at 110, and the method may include receiving by a computer implemented module a connection to a financial exchange allowing trading of assets in the exchange. At 120, the method may include receive by a computer implemented module trading rules defined by a trader, the rules being based at least in part on an asset of trade, a trade time-frame, buy and sell rules, quantity of traded asset and machine-defined rules defined by machine learning extracted patterns. At 130, the method may include executing by a trading algorithm a trading process based on received trading rules as a thread in a compute environment, where the trading thread process compute resource utilization may be measured as a portion of available compute resources. Each trading thread process may be identifiable to its unique set of rules and financial exchange connection. Tracking by a trading thread monitor of received trading rules to determine alteration of trading rules received may start a trading process thread based on new rules, or restart a trading process new thread if significant changes to the rules may be determined.

In some embodiments, the module adapted to receive trading rules may comprise a real-time database. In some embodiments, the trading thread monitor may execute the financial exchange connection and trading rules as a processor thread, the thread comprising a trading algorithm identifiable to the received trading rules. In some embodiments, the financial exchange connection may be an API key.

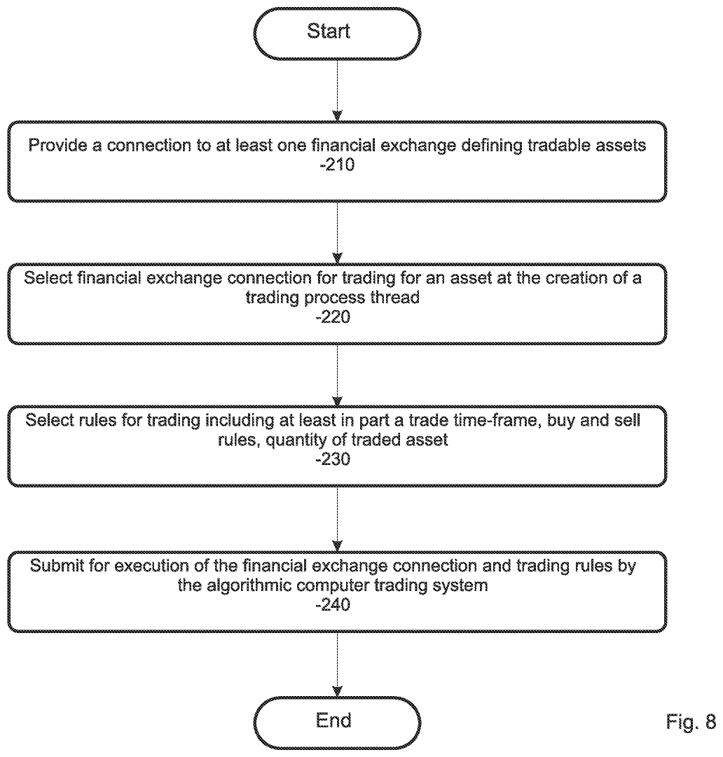

Now referring to FIG. 8 is a flowchart that further describes the method from FIG. 7, according to some embodiments of the present disclosure. In some embodiments, the computer program executing the method, further comprising a consumer module coupled thereto via a data communication network and being adapted to execute the method 210 to 240. Beginning with 210 is the providing of a connection to at least one financial exchange defining tradable assets. Next in 220 is the selecting of a financial exchange connection for trading an asset at the creation of a trading process thread. Next in 230, is the selection or create of rules for trading including at least in part a trade time-frame, buy and sell rules, quantity of traded asset. This is typically achieved using a graphical user interface. In 240, is the submission of the trading rules for execution the financial exchange connection and trading rules by the algorithmic computer trading system. The submitted rules form the basis of execution of a trading thread based on input strategy.

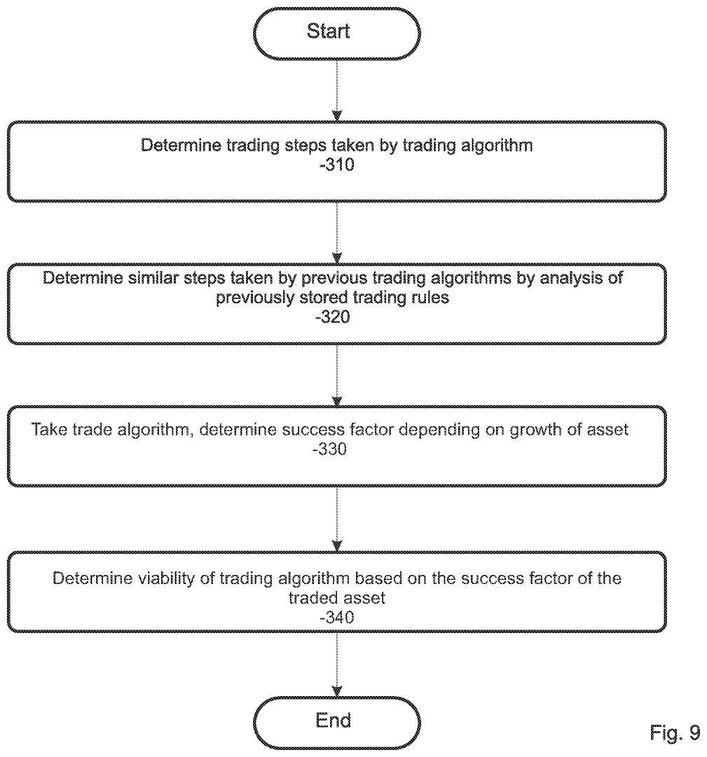

The embodiment according to FIG. 9 is a flowchart that further describes the method from FIG. 7, according to some embodiments of the present disclosure. In some embodiments, the computer program product may further comprise in the trading thread monitor a suitably trained machine learning algorithm that is adapted to perform the method including 310 to 340. In some embodiments, this may further cause the start trading process thread based on modified trading rules. In 310, is the determination of the trading steps taken by the trading algorithm executing the process thread. Next, in 320 is determining from a database comprising historical trading steps, similar steps acting on historical market data by analysis stored previous trading rules. Next, in 330 is determining the success factor based on the trade algorithm growth of asset by executing a trading strategy. Next, in 340 is determining the viability of a trading algorithm based on the success factor of the traded asset as determined by the trained machine learning algorithm.

In some aspects, the flowchart describes a machine learning algorithm for training and deployment in a trading thread monitor. The algorithm is used to determine the trading steps taken by a trading algorithm and to determine similar steps taken by previous trading algorithms by analyzing previously stored trading rules. The success of these similar steps is determined by the growth of the traded asset, which is measured by the increase in asset value after the trading strategy is executed. The value of the asset is stored in a real-time database with each strategy execution or on a continuous basis, as necessary. In some embodiments, the algorithm may be used to modify trading rules in order to maximize the growth of the traded asset, and this modified algorithm is executed by the trading process thread.

In conclusion, the present invention provides a client-server system for analyzing and recommending amendments to trading strategies. The system includes a portable computer with a graphical user interface (GUI) for receiving trading rules from a trader, and a server connected to the portable computer via a network, which comprises a trained machine learning algorithm for analyzing the received trading rules and an output mechanism for recommending amendments to the trading rules based on the analysis. The system also includes input and output mechanisms for communicating between the portable computer and the server, as well as computer-executable instructions embodied on a computer-readable storage medium.

In addition, the system employs dimensionality reduction techniques such as feature selection, Principal Component Analysis (PCA), and Autoencoder to improve the performance of the algorithm and make the training process more efficient. This allows the algorithm to focus on the most important features and patterns, which can help to improve its ability to generalize to new data.

The invention thus provides a powerful and flexible tool for traders to analyze and improve their trading strategies. It enables traders to receive recommendations on how to improve their strategies based on the analysis of their trading rules and current market conditions, and to predict the outcome of trades based on the trading rules and current market conditions. The use of dimensionality reduction techniques allows the system to improve the profitability of the strategy and make the training process more efficient.

The system may use computer-readable program instructions to implement the functions specified in the flowchart and/or block diagram. These instructions may be stored in a computer-readable storage medium, such as a hard drive or flash drive, that can direct a computer, programmable data processing apparatus, or other devices to function in a particular manner.

It is anticipated that the system can be implemented using various modifications, additions, and substitutions, without departing from the scope and spirit of the invention. The system can be modified to suit different user needs, and can be combined with other systems to improve the overall user experience.

It is important to note that the system is intended to embrace all alternatives, modifications, equivalents and variations that are within the spirit and scope of the disclosed subject matter. The system is designed to be flexible and adaptable, so that it can be used in a variety of contexts. Additionally, the system can be used with different devices, and can be customized to suit different user preferences.

### INDUSTRIAL APPLICATION

The invention is applicable in the computing industry, specifically algorithmic trading systems.

What is claimed is:

1. An algorithmic computer trading system for facilitating electronic processing of data for execution of trades, the system comprising:
a computer implemented module adapted to receive a connection to a financial exchange allowing trading of assets in the exchange;
a computer implemented module adapted to receive trading rules defined by a trader, the rules being based at least in part on an asset of trade, a trade time-frame, buy and sell rules, quantity of traded asset and machine-defined rules defined by machine learning extracted patterns;
a trading algorithm executing a trading process based on received trading rules as a thread in a compute environment, where the trading thread process compute resource utilization may be measured as a portion of available compute resources, and wherein each trading thread process is identifiable to its unique set of rules and financial exchange connection, and;
a trading thread monitor adapted to keep track of received trading rules to determine alteration of trading rules received thus start a trading process thread based on new rules, or restart a trading process new thread if significant changes to the rules is determined.

2. The trading system of claim 1, further comprising a consumer module coupled thereto via a data communication network and being adapted to:
provide a connection to at least one financial exchange defining tradable assets;
select a financial exchange connection for trading an asset at the creation of a trading process thread;
select/create rules for trading including at least in part a trade time-frame, buy and sell rules, quantity of traded asset, and;
submit for execution the financial exchange connection and trading rules by the algorithmic computer trading system.

3. The trading system of claim 1, wherein the module adapted to receive trading rules comprises a real-time database.

4. The trading system of claim 1, wherein the trading thread monitor executes the financial exchange connection and trading rules as a processor thread, the thread comprising a trading algorithm identifiable to the received trading rules.

5. The trading system of claim 1, wherein the financial exchange connection is an API key.

6. The trading system of claim 1, further comprising in the trading thread monitor a suitably trained machine learning algorithm adapted to:
determine the trading steps taken by a trading algorithm;
determine similar steps taken by previous trading algorithms by analysis of previously stored trading rules;
determining the success of similar steps based on the growth of traded asset, and;
modifying the trading rules to maximize the growth of traded asset.

7. The trading system of claim 6, further causing the start trading process thread based on modified trading rules.

8. The trading system of claim 6, wherein the growth of asset is determined by increase in asset value after trading strategy execution, with the value being stores in a real-time database.

9. A computer program product comprising a sequence of instructions stored on a non-transitory computer readable medium, which computer program when executed causes the execution of a method comprising:
receiving by a computer implemented module a connection to a financial exchange allowing trading of assets in the exchange;
receive by a computer implemented module trading rules defined by a trader, the rules being based at least in part on an asset of trade, a trade time-frame, buy and sell rules, quantity of traded asset and machine-defined rules defined by machine learning extracted patterns;
executing by a trading algorithm a trading process based on received trading rules as a thread in a compute environment, where the trading thread process compute resource utilization may be measured as a portion of available compute resources, and wherein each trading thread process is identifiable to its unique set of rules and financial exchange connection, and;
tracking by a trading thread monitor of received trading rules to determine alteration of trading rules received thus start a trading process thread based on new rules, or restart a trading process new thread if significant changes to the rules is determined.

10. The computer program product of claim 9, further comprising a consumer module coupled thereto via a data communication network and being adapted to:
provide a connection to at least one financial exchange defining tradable assets;
select a financial exchange connection for trading an asset at the creation of a trading process thread;
select/create rules for trading including at least in part a trade time-frame, buy and sell rules, quantity of traded asset, and;
submit for execution the financial exchange connection and trading rules by the algorithmic computer trading system.

11. The computer program product of claim 9, wherein the module adapted to receive trading rules comprises a real-time database.

12. The computer program product of claim 9, wherein the trading thread monitor executes the financial exchange connection and trading rules as a processor thread, the thread comprising a trading algorithm identifiable to the received trading rules.

13. The computer program product of claim 9, wherein the financial exchange connection is an API key.

14. The computer program product of claim 9, further comprising in the trading thread monitor a suitably trained machine learning algorithm adapted to:
determine the trading steps taken by a trading algorithm;
determine similar steps taken by previous trading algorithms by analysis of previously stored trading rules;
determining the success of similar steps based on the growth of traded asset, and;
modifying the trading rules to maximize the growth of traded asset.

15. The computer program product of claim 14, further causing the start trading process thread based on modified trading rules.

16. The computer program product of claim 14, wherein the growth of asset is determined by increase in asset value after trading strategy execution, with the value being stores in a real-time database.
